(19) United States
(12) Patent Application Publication
(10) Pub. No.: US 2022/0409474 A1
(43) Pub. Date: Dec. 29, 2022

(54) MOVABLE LIMB COMPRESSION AND CIRCULATION APPARATUS

(71) Applicant: SUNMEDIX CO.,LTD, Namyangju-si (KR)

(72) Inventors: Yong Mahn KIM, Namyangju-si (KR); Hyoung Chul SHIN, Seoul (KR)

(21) Appl. No.: 17/356,002

(22) Filed: Jun. 23, 2021

(51) Int. Cl. A61H 9/00

(52) U.S. Cl. CPC A61H 9/0092; A61H 2201/0103; A61H 2201/0157; A61H 2201/5071; A61H 2201/5007; A61H 2201/5048

(57) ABSTRACT

Provided is a limb compression and circulation apparatus in which, due to a small and light body and a rechargeable power supply device, the limb compression and circulation apparatus is usable regardless of place while being worn and used by a user who is moving. The limb compression and circulation apparatus may include a first air hose connected to one end of an air pressurization portion to send air generated by the air pressurization portion and a plurality of second air hoses connected to the other end of the first air hose and allowing the air generated by the air pressurization portion to diverge and to blow into an air cuff so as to perform effective air divergence. The limb compression and circulation apparatus may prevent air leakage by coupling an air inlet/outlet hole of a second adaptor with an air hose to communicate with each other.

### BACKGROUND

### 1. Field of the Invention

The present invention relates to a movable limb compression and circulation apparatus, and more particularly, to a movable limb compression and circulation apparatus which is usable regardless of a place by using a small and light casing body and a rechargeable power supply device and is worn and used by a user while the user is moving.

### 2. Discussion of Related Art

Generally, as a method of reducing venous pressure by improving circulation of venous blood below a part blocked by blood clots, there are a method of assisting circulation of venous blood by wearing medical high elastic compressing stockings and contracting gastrocnemius myocutaneous through ankle exercise, a method of assisting blood to circulate using gravity by making calves higher than a chest, and the like.

In addition, as one of best methods of treating and preventing melosalgia or edema and varices caused by blood-flow disorders, treatment is performed by autotherapy power by reinforcing peripheral muscles.

As the conventional treatment, there is widely performed a method of treating and relaxing a diseased condition through physical therapy that reinforces muscles or a method of performing massages, practicing acupressure treatment, or the like to smoothly perform blood circulation by stimulating acupoints.

That is, practicing acupressure treatment or massage is a type of manual treatment of treating a disease and improving health by correcting modulation of a body by initiating vital reaction by dynamically stimulating the skin mainly using the hands in a certain way, in which, through practicing acupressure treatment or massage, circulation of blood or lymph is promoted, metabolism is activated, nutrition of tissue is increased, waste is excreted, and resistance is built up.

Since touch-pressure stimulation acts as a pain reliever by stimulating nerves, there are effects of promoting restoration of paralyed nerves and correcting modulation of visceral function.

However, since it is generally impossible for a person alone who receives treatment to perform a medical procedure of practicing acupressure treatment and massage, there is difficulty in receiving assistance from others and an effect is not uniform due to being performed depending on a human force.

In order to reduce the above problems, conventionally, practicing acupressure treatment or massage devices configured to autonomously receive practicing acupressure treatment or massage have been developed. There are disclosed a vibration massage device configured to vibrate a vibrating tool using a driving source and a pneumatic massage device using air pressure.

Conventional vibration massage devices employ a method of vibrating pressing tools using a driving source such as a vibration motor, a solenoid, or the like. Here, since most of such vibration practicing acupressure treatment devices employ a method of repeatedly hitting (beating) a body part, an effect of practicing acupressure treatment is low and secondary pain is caused by the hitting. Also, since it is necessary to press pressing tools on a body part in order to completely transfer vibrations of the pressing tools, inconvenience in use is great and force is necessary such that it is difficult to continuously use the device.

Meanwhile, conventional pneumatic massage devices employ a method in which an air pressure repeatedly acts on a cuff configured to surround a body part of a user using compressed air generated by a pump. Most pneumatic massage devices are configured to repeatedly apply pressure to a body part by injecting and discharging air into the cuff configured to surround an arm or leg part.

However, in pneumatic massage devices according to the related art, since stimuli are added to local parts of a human body in contact with a plurality of air chambers configured to simply expand or contract, a massage effect is low.

That is, since several air chambers merely repeat expansion and contraction due to a simple action of air pressure so as to simply press a body part on which the cuff is worn by applying a certain pressure, it is difficult to expect a massage effect of stimulating acupoints.

As the related art for remedying such problems, Korean Utility Model Registration No. 20-0447803 (Feb. 12, 2010) discloses a limbs compressible air massage apparatus. Here, claim 1 discloses a limbs compressible air massage apparatus including a cuff which surrounds a body part to be massaged, repeatedly performs expansion and contraction according to a change in pneumatic pressure formed therein, and compresses the body part, a plurality of divided air pouches of the cuff, a pneumatic pressure generator configured to form a certain air pressure by adjusting an air amount supplied to an inside of the air pouches, and an air hose configured to transfer pneumatic pressure from the pneumatic pressure generator to the air pouches. Here, the air pouches each include a tube layer expanded and contracted by the pneumatic pressure and a protection layer enclosing an outer surface of the tube layer. The protection layer includes a plurality of pressing protrusions protruding in a direction to come into contact with a body. The pressing protrusions each include a pressing protrusion body having a bottom end fixedly installed on the protection layer and a pressing protrusion cover detachably fitting on an upper side of the pressing protrusion body. The limbs compressible air massage apparatus according to the related art includes the plurality of pressing protrusions protruding in the direction to come into contact with the body so that the pressing protrusions stimulate a body of a user while expansion and contraction are performed by the pneumatic pressure.

However, in the limbs compressible air massage apparatus according to the related art, since the pressing protrusions are fixed, stimulation is repeatedly applied only to a local part of the body corresponding to the pressing protrusions such that pain is caused and stimuli are applied even to a body part which does not need stimulation. Accordingly, customer dissatisfaction is caused.

Meanwhile, since pneumatic massage devices according to several related arts have a structure in which a massage is performed while leg or arm parts of a body are completely surrounded, that is, in as state of wearing the device such that ventilation is difficult, the device is contaminated by perspiration or secretion discharged by a user. To overcome the above limitations, although the device is used after a disposable nonwoven fabric or a cotton cover is worn on the body, there are difficulties and inconvenience in use.

In addition, in the case of the pneumatic massage devices according to the related art, most users receive massages while sitting in a sofa or a chair. Here, a phenomenon in which a cuff comes off is present such that there is inconvenience of needing to pull up the cuff which is coming off while the user receives massages.

Also, it is impossible to receive a necessary massage action in a place other than where a pneumatic massage device is disposed.

### SUMMARY OF THE INVENTION

The present invention is directed to providing a limb compression and circulation apparatus in which, due to a small and light body and a rechargeable power supply device, the limb compression and circulation apparatus is usable regardless of place while being worn and used by a user who is moving.

The present invention is also directed to providing a first air hose connected to one end of an air pressurization portion to send air generated by the air pressurization portion and a plurality of second air hoses connected to the other end of the first air hose and allowing the air generated by the air pressurization portion to diverge and to blow into an air cuff so as to perform effective air divergence.

The present invention is also directed to preventing air leakage by coupling an air inlet/outlet hole of a second adaptor with an air hose using an O-ring to communicate with each other.

The present invention is also directed to providing air compression portions provided symmetrically and a body attachment device provided on one surface so as to wear the air cuff in any one direction of left and right directions.

The present invention is also directed to inputting a variety of massage modes and a variety of pressure modes (or values) which are set by a user and to monitoring an operation state through a control portion including an input portion and an output portion.

The present invention is also directed to providing pressure sensing portions in the second air hoses to sense and separately control pressures of the respective air compression portions.

The present invention is also directed to collecting the pressures of the air compression portions, to driving the air pressurization portion, and opening or closing an opening or closing device so as to automatically increase or decrease the pressures of the air compression portions.

The present invention is also directed to outputting a beep sound when pressure information collected by the pressure sensing portions is greater than a preset pressure value and stopping an operation of the air pressurization portion so as to prevent an accident and inconvenience in use.

The present invention is also directed to driving the air pressurization portion again when the pressure information collected by the pressure sensing portions returns to be within the preset pressure value so as to continuously perform a normal operation without user intervention.

The present invention is also directed to coupling the second adaptor coupled to and communicating with a first adaptor in only a forward direction so as to prevent air leakage caused by negligence of the user.

Meanwhile, the technical aspects achievable by the present invention are not limited to the above-stated aspects and other unstated aspects may be clearly understood by one of ordinary skill in the art from the following disclosure.

According to an aspect of the present invention, there is provided a movable limb compression and circulation apparatus. The movable limb compression and circulation apparatus includes a casing (100) including a front portion (101) and a rear portion (102) detachably coupled to each other to form an exterior of the apparatus, an input/output accommodation groove (103) formed in one surface of the front portion (101), a power supply accommodation portion (104) disposed at a bottom end of an internal portion between the front portion (101) and the rear portion (102) which are coupled, a wire guide portion (105) provided inward from a side surface to allow a connection wire to enter or exit from the power supply accommodation portion (104), and an air generation accommodation portion (106) formed at a position right above the power supply accommodation portion (104).

The movable limb compression and circulation apparatus may include a power supply portion (200) accommodated and mounted in the power supply accommodation portion (104).

The movable limb compression and circulation apparatus may include an air pressurization portion (300) mounted on the air generation accommodation portion (106) to be driven by power of the power supply portion (200).

The movable limb compression and circulation apparatus may include first air hose portions (400) disposed on both sides of the air generation accommodation portion (106) to send air generated by the air pressurization portion (300) and including one ends communicating with the air compression portion (300).

The movable limb compression and circulation apparatus may include a plurality of second air hose portions (410) connected to the other ends of the first air hose portions (400) and configured to blow the air generated by the air pressurization portion (300).

The movable limb compression and circulation apparatus may include an opening or closing device (411) provided in the middle of any one or all of the first air hose portions (400) or the second air hose portions (410).

The movable limb compression and circulation apparatus may include an air inlet/outlet portion (500) including a first adaptor (501) disposed on one side surface of the casing (100) to be parallel to an air-blowing direction of the second air hose portions (410) and configured to communicate with the second air hose portions (410) through hoses to allow an interior and exterior of the casing (100) to communicate with each other, a second adaptor (502) inserted into and fastened to the first adaptor (501), and an air inlet/outlet hole (503) coupled to the second adaptor (502).

The movable limb compression and circulation apparatus may include an air cuff (600) including a plurality of air compression portions (602) connected to an air hose (601) detachably coupled to the air inlet/outlet hole (503).

The movable limb compression and circulation apparatus may include a control portion (700) configured to control the power supply portion (200) and the opening or closing device (411) using input information of an input portion (701) accommodated in the input/output accommodation groove (103) and information collected by a timer (702) or a pressure sensing portion (703) therein, output information to an output portion (704) accommodated in the input/output accommodation groove (103), and set a value of pressurization generated by the air pressurization portion (300) in advance.

The air cuff (600) may further include a body attachment device (603) on one surface thereof.

The air inlet/outlet portion (500) may be configured so that the second adaptor (502) is inserted into and coupled to the first adaptor (501) only in a forward direction.

The air hose (601) and the air inlet/outlet hole (503) of the second adaptor (502) may be coupled to each other using an O-ring.

The air compression portion (602) may include a central compression portion (602a), peripheral compression portions (602b) arranged outside the central compression portion (602a), and external curved portions (602c) formed so that both ends of the peripheral compression portions (602b) are curved outward to deviate further outward from a central line, and the air compression portion (602) may be formed of polyvinyl chloride (PVC).

The air compression portion (602) may be configured so as to gradually increase a compression space portion (604) by mutually forming a V-shape outward from a central location on the basis of the central compression portion (602a).

The air cuff (600) may be provided to be worn in any one direction of leftward and rightward directions.

The control portion (700) may be configured to sequentially compress the air compression portions (602) one by one using pressure information collected by the pressure sensing portion (703).

The control portion (700) may drive the air pressurization portion (300) and may open or close the opening or closing device (411) so as to control pressures of the air compression portions (602) to differ from or be equal to each other.

The control portion (700) may be configured to output a beep sound through the output portion (704) and stop an operation of the air pressurization portion (300) when the pressure information collected by the pressure sensing portion (703) is greater than a preset pressure value, and the control portion may be configured to drive the air pressurization portion (300) again when a measured pressure value returns to be within a preset setting value while the preset pressure value is provided to be adjustable for each step according to a setting mode.

### BRIEF DESCRIPTION OF THE DRAWINGS

The following drawings attached to the specification illustrate exemplary embodiments of the present invention and further allow understanding of the technical concept of the present invention with the following detailed description of the present invention. However, the present invention should not be construed while being limited to items shown in the drawings:

FIG. 1 is a three-dimensional view illustrating an exterior of a casing which includes a front portion and a rear portion in a movable limb compression circulation apparatus according to one exemplary embodiment of the present invention;

FIG. 2 is a three-dimensional view illustrating an internal layout of the casing of the movable limb compression and circulation apparatus according to one exemplary embodiment of the present invention;

FIGS. 3 and 4 are three-dimensional views illustrating a coupling relationship between first and second adaptor portions disposed on one end of the casing of the movable limb compression and circulation apparatus according to one exemplary embodiment of the present invention;

FIG. 5 is a photo illustrating an air cuff of the movable limb compression and circulation apparatus according to one exemplary embodiment of the present invention;

FIGS. 6 and 7 are conceptual views illustrating an air pressurization portion and first and second air hose portions of the movable limb compression and circulation apparatus according to one exemplary embodiment of the present invention;

FIGS. 8 and 9 are a block diagram and a flowchart illustrating a control structure of the movable limb compression and circulation apparatus according to one exemplary embodiment of the present invention;

FIG. 10 is a photo of a state of use illustrating a state in which the movable limb compression and circulation apparatuses according to one exemplary embodiment of the present invention are worn on left and right legs at the same time;

FIG. 11 is a photo of a state of use illustrating a variety of contents of an output portion of the movable limb compression and circulation apparatuses according to one exemplary embodiment of the present invention; and

FIG. 12 is a photo of a state of use illustrating a state in which a variety of input modes are set using an input portion of the movable limb compression and circulation apparatuses according to one exemplary embodiment of the present invention.

### DETAILED DESCRIPTION OF EXEMPLARY EMBODIMENTS

A particularly structural or functional description of embodiments according to the concept of the present invention disclosed in the specification is merely an example for describing embodiments according to the concept of the present invention, and the embodiments of the concept of the present invention may be implemented to have a variety of forms and are not limited to embodiments described in the specification.

Since a variety of modifications of the embodiments according to the concept of the present invention may be made and a variety of forms thereof may be provided, the embodiments are illustrated in the drawings and will be described in detail in the specification. However, the embodiments according to the concept of the present invention are not intended to be limited to particularly disclosed forms and include all changes, equivalents, or substitutes within the concept and technical scope of the present invention.

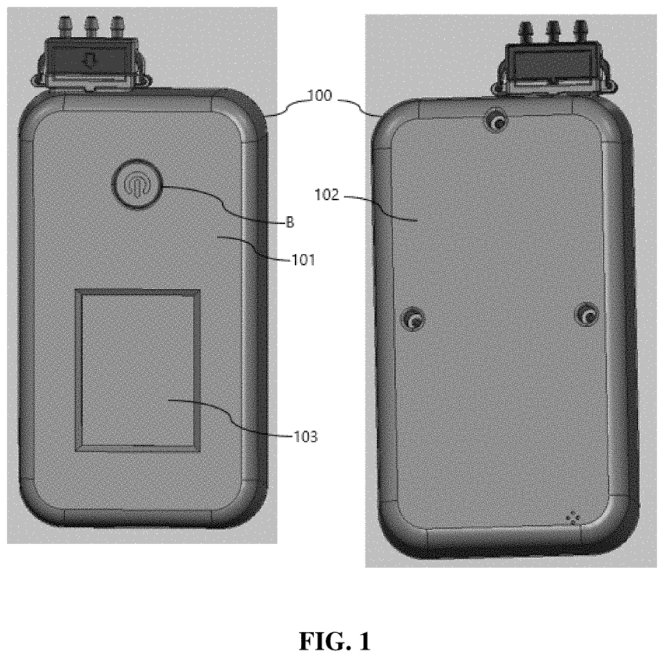

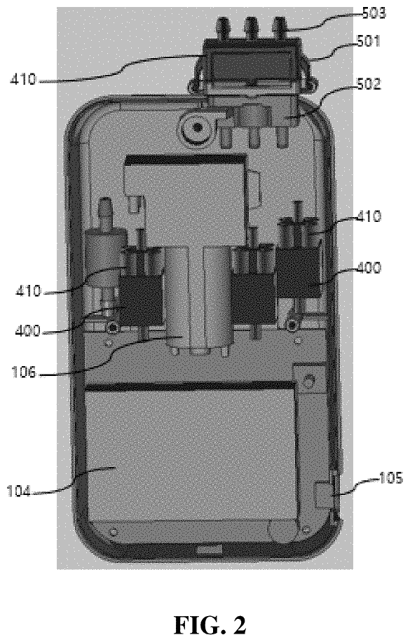

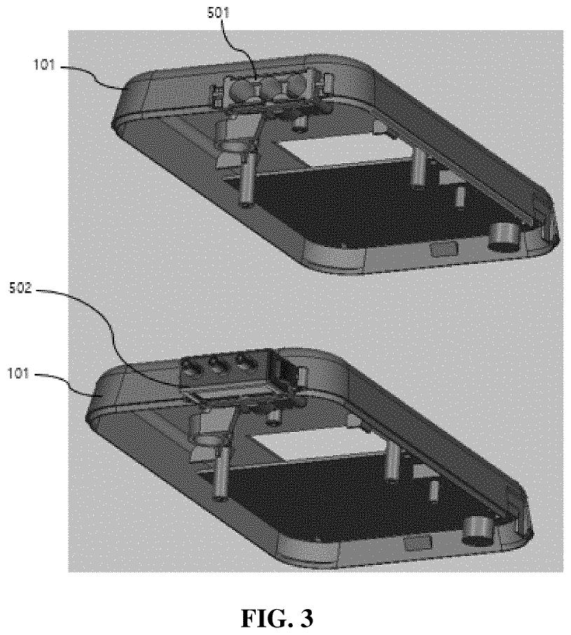

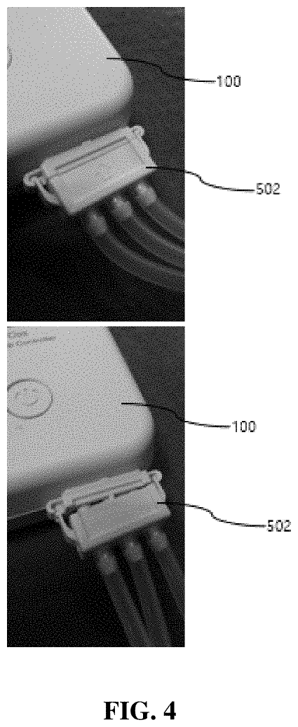

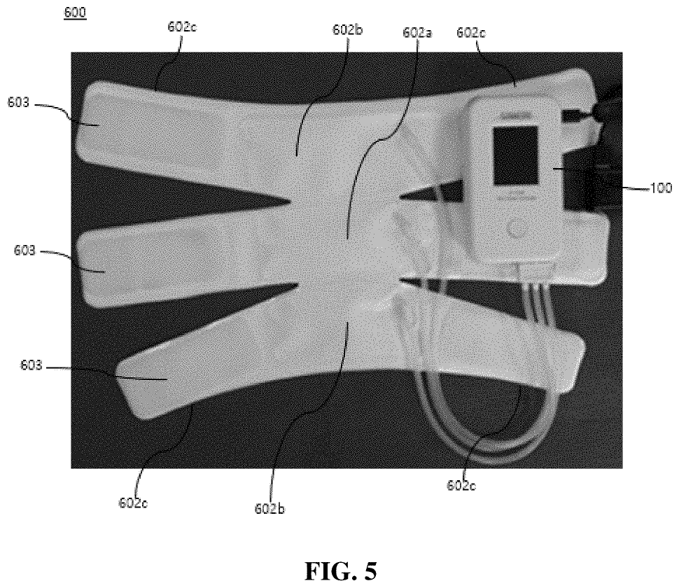

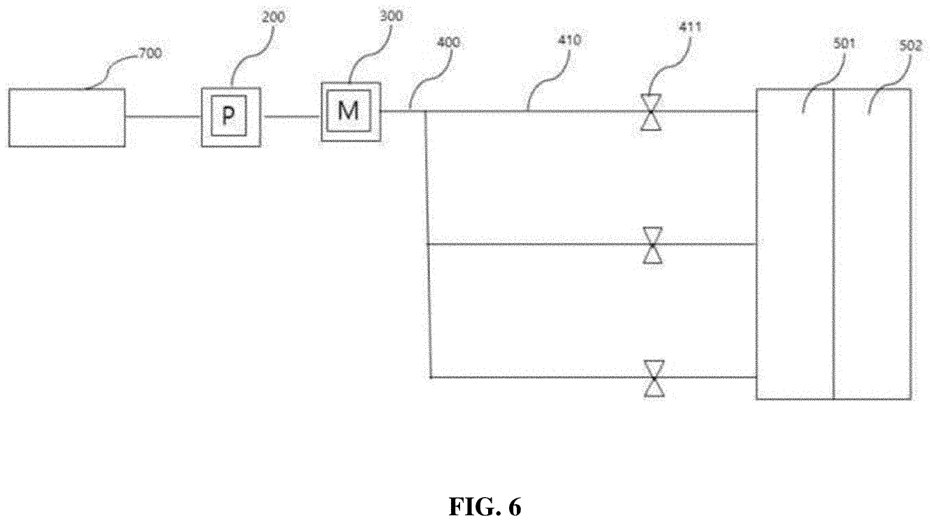

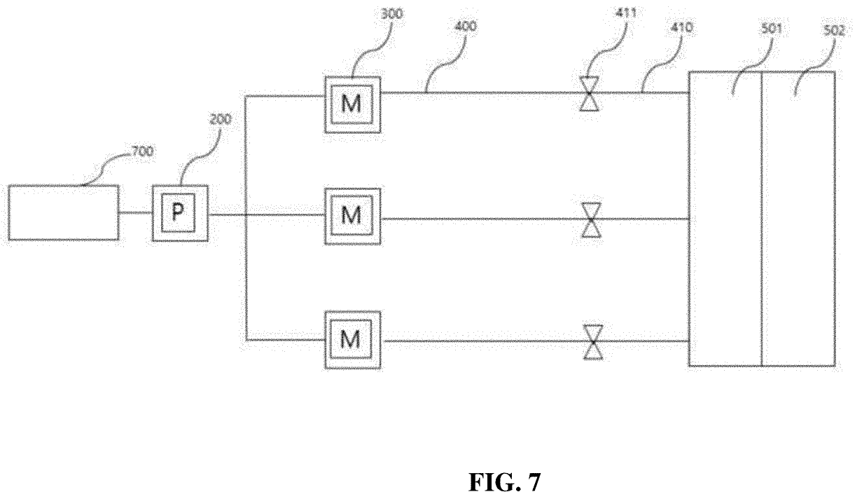

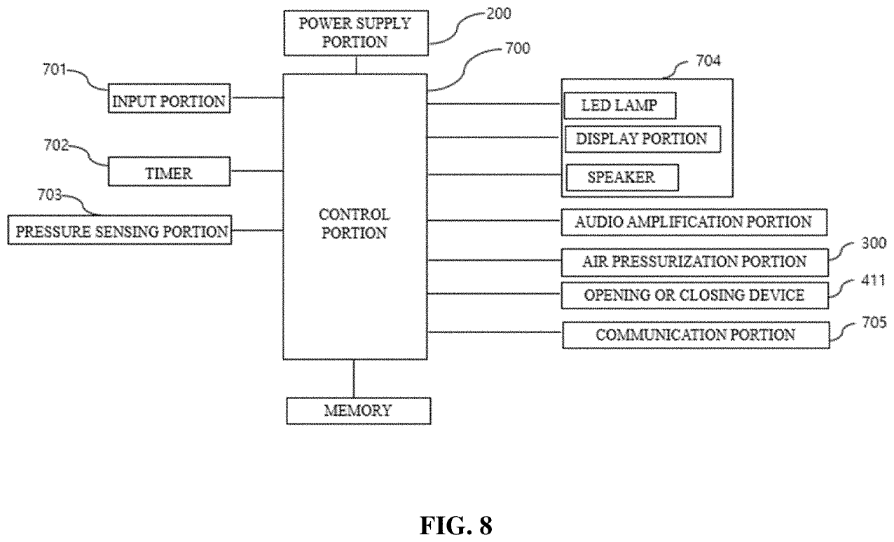

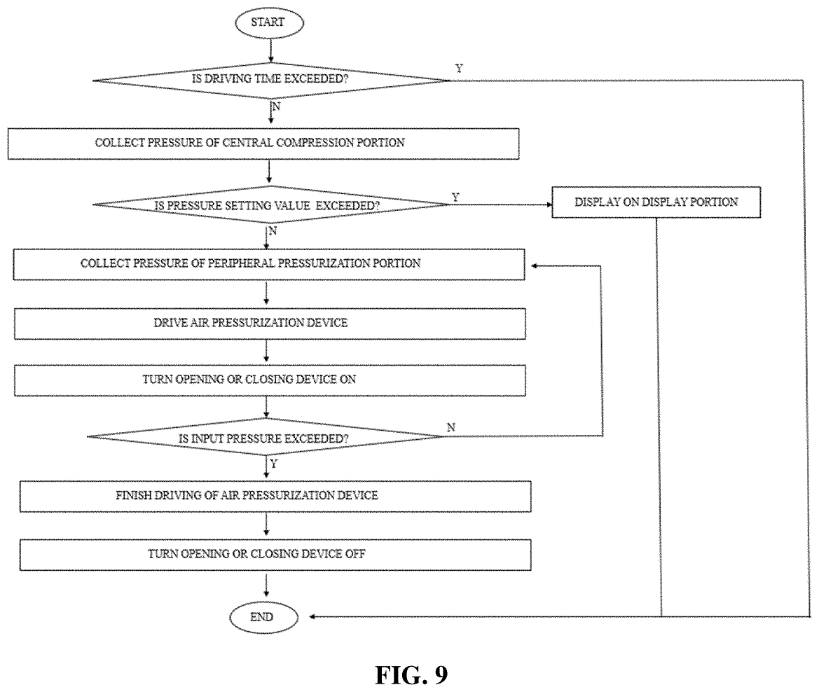

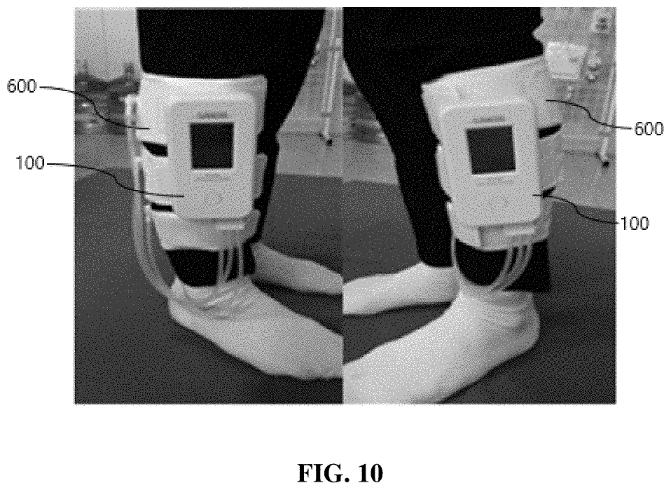

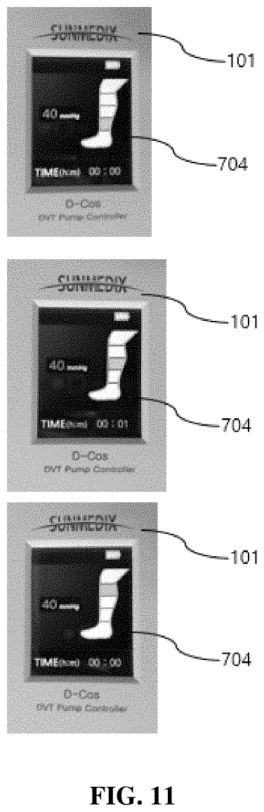

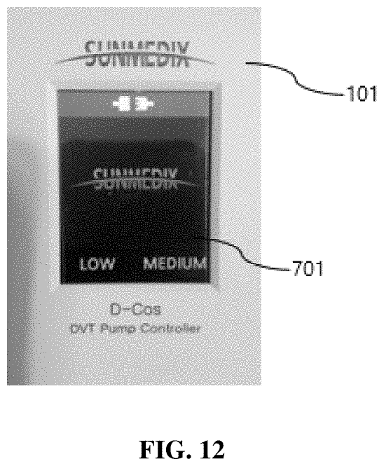

FIG. 1 is a three-dimensional view illustrating an exterior of a casing which includes a front portion and a rear portion in a movable limb compression circulation apparatus according to one exemplary embodiment of the present invention, FIG. 2 is a three-dimensional view illustrating an internal layout of the casing of the movable limb compression and circulation apparatus according to one exemplary embodiment of the present invention, FIGS. 3 and 4 are three-dimensional views illustrating a coupling relationship between first and second adaptor portions disposed on one end of the casing of the movable limb compression and circulation apparatus according to one exemplary embodiment of the present invention, FIG. 5 is a photo illustrating an air cuff of the movable limb compression and circulation apparatus according to one exemplary embodiment of the present invention, FIGS. 6 and 7 are conceptual views illustrating an air pressurization portion and first and second air hose portions of the movable limb compression and circulation apparatus according to one exemplary embodiment of the present invention, FIGS. 8 and 9 are a block diagram and a flowchart illustrating a control structure of the movable limb compression and circulation apparatus according to one exemplary embodiment of the present invention, FIG. 10 is a photo of a state of use illustrating a state in which the movable limb compression and circulation apparatuses according to one exemplary embodiment of the present invention are worn on left and right legs at the same time, FIG. 11 is a photo of a state of use illustrating a variety of contents of an output portion of the movable limb compression and circulation apparatuses according to one exemplary embodiment of the present invention, and FIG. 12 is a photo of a state of use illustrating a state in which a variety of input modes are set using an input portion of the movable limb compression and circulation apparatuses according to one exemplary embodiment of the present invention.

First, as shown in FIGS. 1 and 2, the movable limb compression and circulation apparatus according to the present application includes a casing 100 including a front portion 101 and a rear portion 102 detachably coupled to each other to form an exterior of the apparatus, an input/output accommodation groove 103 formed in one surface of the front portion 101, a power supply accommodation portion 104 disposed at a bottom end of an internal portion between the front portion 101 and the rear portion 102 which are coupled, a wire guide portion 105 provided inward from a side surface to allow a connection wire to enter or exit from the power supply accommodation portion 104, and an air generation accommodation portion 106 formed at a position right above the power supply accommodation portion 104.

Also, a power supply portion 200 disposed to be accommodated and mounted in the power supply accommodation portion 104 is provided.

The power supply portion 200 may be provided as a rechargeable battery to be usable while moving and may be charged through the wire guide portion 105.

Meanwhile, an air pressurization portion 300 is provided that is mounted on the air generation accommodation portion 106 to be driven by power of the power supply portion 200.

Here, the air pressurization portion 300 may be provided as any one of an air blower, an air fan, and the like driven by a motor and a small air compressor. In the case of provision of an air compressor, the air compressor may be provided as an oilless compressor which is harmless to a human body.

Also, first air hose portions 400 are provided that are disposed on both sides of the air generation accommodation portion 106 to send air generated by the air pressurization portion 300 and having one ends communicating with the air pressurization portion 300, and a plurality of second air hose portions 410 are provided that are connected to the other ends of the first air hose portions 400 to blow the air generated by the air pressurization portion 300.

Here, as shown in FIGS. 6 and 7, a single air hose departing from the air pressurization portion 300 may diverge into a plurality of air hoses. Otherwise, a plurality of air hoses may be provided from the air pressurization portion 300.

Meanwhile, an opening or closing device 411 is provided in the middle of any one or all of the air hose portions 400 or the second air hose portions 410 so as to turn an air-blowing flow on or off.

Here, as shown in FIG. 3, an air inlet/outlet portion 500 includes a first adaptor 501 disposed on one side surface of the casing 100 to be parallel to an air-blowing direction of the second air hose portions 410 and configured to communicate with the second air hose portions 410 through hoses to allow an interior and exterior of the casing 100 to communicate with each other, a second adaptor 502 inserted into and fastened to the first adaptor 501, and an air inlet/outlet hole 503 coupled to the second adaptor 502.

As shown in FIGS. 4 and 5, an air cuff 600 including an air hose 601 detachably provided and a plurality of air compression portions 602 connected to the air hose 601 may be provided on the air inlet/outlet hole 503 so as to massage or compress a wearer.

Here, as shown in FIGS. 8, 11, and 12, there is provided a control portion 700 configured to control the power supply portion 200 and the opening or closing device 411 and to allow the output portion 704 to output information using input information of the input portion 701 accommodated in the input/output accommodation groove 103 and information collected by a timer 702 or a pressure sensing portion 703 which is included therein.

Here, as shown in FIG. 5, the air cuff 600 further includes a body-attachment device 603 on one surface thereof and the body-attachment device 603 may be, for example, Velcro.

Meanwhile, as shown in FIG. 4, in the air inlet/outlet portion 500, the first adaptor 501 and the second adaptor 502 are provided to be inserted only in a forward direction and coupled to each other so as to prevent air leakage caused by negligence by a user.

In addition, the air hose 601 and the air inlet/outlet hole 503 of the second adaptor 502 are coupled using an O-ring so as to prevent air leakage between the air inlet/outlet hole 503 and the air hose 601.

Meanwhile, as shown in FIG. 5, the air compression portion 602 includes a central compression portion 602a, a peripheral compression portions 602b arranged outside the central compression portion 602a, and external curved portions 602c formed so that both ends of the peripheral compression portions 602b are curved outward to deviate further outward from a central line, and the air compression portion 602 is formed of polyvinyl chloride (PVC) so as to effectively perform compression, to be prevented from being contaminated, and to be easily cleaned.

Also, as shown in FIG. 10, the air compression portion 602 is provided to gradually increase a compression space portion 604 by mutually forming a V-shape outward from a central position on the basis of the central compression portion 602a so as to effectively compress a worn target part while being fully filled with air as well as being worn in any one of leftward and rightward directions.

Meanwhile, as shown in FIG. 9, the control portion 700 is configured to sequentially compress the air compression portions 602 one by one using pressure information collected by the pressure sensing portion 703.

That is, as one embodiment, the control portion 700 is configured to control upper compression, upper decompression and intermediate compression, intermediate decompression and lower compression, lower decompression and intermediate compression, intermediate decompression and upper compression, and the like while the air cuffs 600 are worn on legs so as to provide a wearer with a manually massaging effect.

In addition, the control portion 700 may be configured to control pressures of the air compression portion 602 by driving the air pressurization portion 300 and opening or closing the opening or closing device 411 so as to implement compression and decompression at the same time.

Here, the control portion 700 may be configured to output a beep sound through the output portion 704 and stop an operation of the air pressurization portion 300 when the pressure information collected by the pressure sensing portion 703 is greater than a preset pressure value. However, the control portion may be configured to drive the air pressurization portion 300 again when a measured pressure value returns to be within a preset setting value. Here, the preset pressure value is provided to be adjustable for each step according to a setting mode as shown in FIG. 12.

According to the present invention, due to a small and light body and a rechargeable power supply device, convenience is provided due to a limb compression and circulation apparatus being usable regardless of place while being worn and used by a user moving. A first air hose is connected to one end of an air pressurization portion to send air generated by the air pressurization portion, and a plurality of second air hoses connected to the other end of the first air hose and allowing the air generated by the air pressurization portion to diverge and to be blown to an air cuff are provided so as to perform effective air divergence. Air leakage is prevented by coupling an air inlet/outlet hole of a second adaptor with an air hose using an O-ring to communicate with each other. Air compression portions may be provided symmetrically and a body attachment device may be provided on one surface so as to provide an effect of wearing the air cuff in any one direction of left and right directions. A variety of massage modes and a variety of pressure modes (or values) which are set by a user are input and an operation state is conveniently monitored through a control portion including an input portion and an output portion. Since pressure sensing portions are provided in the second air hoses to sense and separately control pressures of the respective air compression portions, a massage effect may be increased. The pressures of the air compression portions may be collected, the air pressurization portion may be driven, and an opening or closing device may be opened or closed so as to automatically increase or decrease the pressures of the air compression portions. When pressure information collected by the pressure sensing portions is greater than a preset pressure value, a beep sound may be output and an operation of the air pressurization portion may be stopped so as to prevent an accident while the device is in use. When the pressure information collected by the pressure sensing portions returns to be within the preset pressure value, the air pressurization portion may be driven again so that a normal operation is performed without user intervention. The second adaptor coupled to and communicating with a first adaptor may be coupled in only a forward direction so as to prevent air leakage caused by negligence of the user.

According to the present invention, a movable limb compression and circulation apparatus having the following effects is provided.

First, due to a small and light body and a rechargeable power supply device, convenience is provided due to a limb compression and circulation apparatus being usable regardless of place while being worn and used by a user moving.

Second, a first air hose is connected to one end of an air pressurization portion to send air generated by the air pressurization portion, and a plurality of second air hoses connected to the other of the first air hose and allowing the air generated by the air pressurization portion to diverge and to be blown to an air cuff are provided so as to perform effective air divergence. Third, air leakage is prevented by coupling an air inlet/outlet hole of a second adaptor with an air hose using an O-ring to communicate with each other.

Fourth, air compression portions can be provided symmetrically and a body attachment device can be provided on one surface so as to wear the air cuff in any one direction of left and right directions.

Fifth, a variety of massage modes and a variety of pressure modes (or values) which are set by a user are input and an operation state is conveniently monitored through a control portion including an input portion and an output portion.

Sixth, since pressure sensing portions are provided in the second air hoses to sense and separately control pressures of the respective air compression portions, a massage effect can be increased.

Seventh, the pressures of the air compression portions can be collected, the air pressurization portion can be driven, and an opening or closing device can be opened or closed so as to automatically increase or decrease the pressures of the air compression portions.

Eighth, when pressure information collected by the pressure sensing portions is greater than a preset pressure value, a beep sound can be output and an operation of the air pressurization portion can be stopped so as to prevent an accident while the device is in use.

Ninth, when the pressure information collected by the pressure sensing portions returns to be within the preset pressure value, the air pressurization portion can be driven again so that there is convenience in which a normal operation is performed without user intervention.

Tenth, the second adaptor coupled to and communicating with a first adaptor can be coupled in only a forward direction so as to prevent air leakage caused by negligence of the user.

Meanwhile, the effects obtainable by the present invention are not limited to the above-stated effects and other unstated effects may be definitely understood by one of ordinary skill in the art from the above detailed description.

Although one exemplary embodiment of the present invention has been described above, it should be understood by one of ordinary skill in the art that the embodiment merely exemplifies the technical concept of the present invention and a variety of changes may be made without departing from the scope of the technical concept of the present invention. Accordingly, the scope of the present invention should be construed by the disclosure of the claims instead of a particular embodiment and it should be construed that all technical concepts within the equivalent range thereof are included in the scope of the present invention.

What is claimed is:

1. A movable limb compression and circulation apparatus comprising:
a casing (100) including a front portion (101) and a rear portion (102) detachably coupled to each other to form an exterior of the apparatus, an input/output accommodation groove (103) formed in one surface of the front portion (101), a power supply accommodation portion (104) disposed at a bottom end of an internal portion between the front portion (101) and the rear portion (102) which are coupled, a wire guide portion (105) provided inward from a side surface to allow a connection wire to enter or exit from the power supply accommodation portion (104), and an air generation accommodation portion (106) formed at a position right above the power supply accommodation portion (104);
a power supply portion (200) accommodated and mounted in the power supply accommodation portion (104);
an air pressurization portion (300) mounted on the air generation accommodation portion (106) to be driven by power of the power supply portion (200);
first air hose portions (400) disposed on both sides of the air generation accommodation portion (106) to send air generated by the air pressurization portion (300) and comprising one ends communicating with the air compression portion (300);
a plurality of second air hose portions (410) connected to the other ends of the first air hose portions (400) and configured to blow the air generated by the air pressurization portion (300);
an opening or closing device (411) provided in the middle of any one or all of the first air hose portions (400) or the second air hose portions (410);
an air inlet/outlet portion (500) including a first adaptor (501) disposed on one side surface of the casing (100) to be parallel to an air-blowing direction of the second air hose portions (410) and configured to communicate with the second air hose portions (410) through hoses to allow an interior and exterior of the casing (100) to communicate with each other, a second adaptor (502) inserted into and fastened to the first adaptor (501), and an air inlet/outlet hole (503) coupled to the second adaptor (502);
an air cuff (600) comprising a plurality of air compression portions (602) connected to an air hose (601) detachably coupled to the air inlet/outlet hole (503); and
a control portion (700) configured to control the power supply portion (200) and the opening or closing device (411) using input information of an input portion (701) accommodated in the input/output accommodation groove (103) and information collected by a timer (702) or a pressure sensing portion (703) therein, output information to an output portion (704) accommodated in the input/output accommodation groove (103), and set a value of pressurization generated by the air pressurization portion (300) in advance.

2. The movable limb compression and circulation apparatus of claim 1, wherein the air cuff (600) further comprises a body attachment device (603) on one surface thereof.

3. The movable limb compression and circulation apparatus of claim 1, wherein the air inlet/outlet portion (500) is configured so that the second adaptor (502) is inserted into and coupled to the first adaptor (501) only in a forward direction.

4. The movable limb compression and circulation apparatus of claim 1, wherein the air hose (601) and the air inlet/outlet hole (503) of the second adaptor (502) are coupled to each other using an O-ring.

5. The movable limb compression and circulation apparatus of claim 1, wherein the air compression portion (602) comprises a central compression portion (602a), peripheral compression portions (602b) arranged outside the central compression portion (602a), and external curved portions (602c) formed so that both ends of the peripheral compression portions (602b) are curved outward to deviate further outward from a central line, and the air compression portion (602) is formed of polyvinyl chloride (PVC).

6. The movable limb compression and circulation apparatus of claim 5, wherein the air compression portion (602) is configured so as to gradually increase a compression space portion (604) by mutually forming a V-shape outward from a central location on the basis of the central compression portion (602a).

7. The movable limb compression and circulation apparatus of claim 5, wherein the air cuff (600) is provided to be worn in any one direction of leftward and rightward directions.

8. The movable limb compression and circulation apparatus of claim 5, wherein the control portion (700) is configured to sequentially compress the air compression portions (602) one by one using pressure information collected by the pressure sensing portion (703), and wherein preset pressurization values are set so as to allow left and right sides to differ from each other and to sequentially pressurize the air compression portions (602) one by one in a programming sequence.

9. The movable limb compression and circulation apparatus of claim 8, wherein the control portion (700) drives the air pressurization portion (300) and opens or closes the opening or closing device (411) so as to control pressures of the air compression portions (602) to differ from or be equal to each other.

10. The movable limb compression and circulation apparatus of claim 1, wherein the control portion (700) is configured to output a beep sound through the output portion (704) and stop an operation of the air pressurization portion (300) when the pressure information collected by the pressure sensing portion (703) is greater than a preset pressure value, and the control portion is configured to drive the air pressurization portion (300) again when a measured pressure value returns to be within a preset setting value while the preset pressure value is provided to be adjustable for each step according to a setting mode.
